(19) United States
(12) Patent Application Publication
(10) Pub. No.: US 2025/0100549 A1
(43) Pub. Date: Mar. 27, 2025

(54) ONBOARD ELECTRONIC CONTROL DEVICE

(71) Applicant: HITACHI ASTEMO, LTD., Hitachinaka-shi, Ibaraki (JP)

(72) Inventors: Masato KASAI, Hitachinaka-shi, Ibaraki (JP); Keiichiro NAGATSUKA, Hitachinaka-shi, Ibaraki (JP)

(73) Assignee: HITACHI ASTEMO, LTD., Hitachinaka-shi, Ibaraki (JP)

(21) Appl. No.: 18/846,836

(22) PCT Filed: Apr. 6, 2022
(86) PCT No.: PCT/JP2022/017204

§ 371 Date: Sep. 13, 2024

(51) Int. Cl. B60W 30/095; G06V 20/58; G08G 1/16

(52) U.S. Cl. CPC B60W 30/095; G06V 20/58; G08G 1/167

(57) ABSTRACT

Provided is an inexpensive onboard electronic control device 100 capable of appropriately changing control of an ACC function without depending on map data when an own vehicle next passes another vehicle by protruding to an opposite traffic lane based on a traffic lane traveling direction determination method without erroneous determination in consideration of the other vehicle that passes the own vehicle by protruding to the opposite traffic lane. The onboard electronic control device 100 includes: a start vehicle recognition unit 244 that recognizes the other vehicle starting from a stopped state in another traffic lane different from an own traffic lane in which the own vehicle SV travels based on a recognition result of outside recognition sensors 210, 220 mounted on the own vehicle; SV and

a traveling direction determination unit 245 that determines a traveling direction of a traffic lane around the own traffic lane including the other traffic lane based on a traveling direction of the own traffic lane, a start direction of the started other vehicle, and a traffic lane position of the other traffic lane.

### DESCRIPTION

### Technical Field

The present invention relates to an onboard electronic control device that determines a traveling direction of a traffic lane around an own vehicle and appropriately changes control of a driving support function.

### Background Art

In recent years, an adaptive cruise control (ACC) function of automatically performing acceleration or deceleration of the own vehicle and controlling the own vehicle to travel following a preceding vehicle on a high-standard highway such as a national expressway or a freeway has become widespread. This functionality is mostly designed to be impossible to use on so-called general roads other than high standard highways, or not recommended to use on the general roads. In the future, an operation range of the ACC function is considered to be expanded to general roads, and for this purpose, it is required to perform control in consideration of various driving scenes.

PTL 1 describes a driving traffic lane detection device that determines the presence or absence of an adjacent traffic lane and determines a traveling direction of the adjacent traffic lane from a behavior of another vehicle when there is the adjacent traffic lane.

### CITATION LIST

### Patent Literature

PTL 1: JP 2005-301603 A

### SUMMARY OF INVENTION

### Technical Problem

As an example of the driving scene to be considered in the control of the ACC function, a passing scene during the ACC control is cited as illustrated in FIG. 11.

In FIG. 11, in a preceding vehicle catching up scene 110, while an own vehicle SV is traveling in an own traffic lane L1 at a set vehicle speed using the ACC function, the own vehicle SV catches up with a preceding vehicle OB1, decelerates, maintains a constant inter-vehicle distance, and follows the preceding vehicle OB1.

Subsequently, in a preceding vehicle passing scene 120 in which time elapses after the own vehicle SV catches up with the preceding vehicle OB1, the own vehicle SV protrudes to an opposite traffic lane L2 and passes the preceding vehicle OB1. At this point, in the conventional ACC function, the vehicle speed is automatically accelerated to an original set vehicle speed.

Subsequently, in an original traffic lane return scene 130, a case where an oncoming vehicle OB2 is approaching is considered. At this time, because the own vehicle is automatically accelerated to the original set vehicle speed by intervention of the automatic control, there is a possibility that speed adjustment of the driver is not successful to induce a collision with the oncoming vehicle OB2. Consequently, in the scene, it is necessary to appropriately change the control of the ACC function.

In order to perform the control change as described above, it is necessary to determine whether the traffic lane to which the traffic lane change is made at the time of passing is the traffic lane in the same traveling direction as the own vehicle (forward traveling traffic lane). Such determination can be made based on the map data including traffic lane information and satellite positioning information. However, because the map data is expensive, it is desirable to configure a system that makes the determination based on outside recognition information without depending on the map data. In this case, a method is conceivable in which a traffic lane around the own vehicle is recognized by an outside recognition device, and at the same time, a behavior of another vehicle traveling in the traffic lane is recognized, and the traveling direction of the surrounding traffic lane is determined.

In the case where it is specifically considered to determine the traveling direction of the traffic lane from the behavior of another vehicle traveling in the traffic lane surrounding the own vehicle, when another vehicle traveling in the same traveling direction as the own vehicle exists, the traffic lane to which the another vehicle belongs is determined to be the forward traveling traffic lane.

However, when the above-described traffic lane traveling direction determination method is s applied, when another vehicle that passes the own vehicle while protruding to the opposite traffic lane appears, the another vehicle travels in the same traveling direction as the own vehicle during the passing, and there is a possibility that the opposite traffic lane is erroneously determined as the forward traveling traffic lane.

Consequently, when the own vehicle protrudes to the opposite traffic lane to pass another vehicle, the control of the ACC function cannot be appropriately changed.

PTL 1 only describes the determination of the traveling direction of the adjacent traffic lane based on a distance and a relative speed between the own vehicle and another vehicle traveling in the adjacent traffic lane, and does not consider the case where another vehicle that passes the own vehicle while protruding to the opposite traffic lane appears.

For this reason, an object of the present invention is to inexpensively provide an onboard electronic control device and an onboard electronic control method capable of appropriately changing the control of the ACC function without depending on the map data when the own vehicle next passes another vehicle by protruding to the opposite traffic lane based on a traffic lane traveling direction determination method without erroneous determination in consideration of the another vehicle that passes the own vehicle by protruding to the opposite traffic lane.

### Solution to Problem

In order to achieve the above object, the present invention is configured as follows.

An onboard electronic control device includes: a start vehicle recognition unit that recognizes another vehicle starting from a stopped state in another traffic lane different from an own traffic lane in which an own vehicle travels based on a recognition result of an outside recognition sensor mounted on the own vehicle; and a traveling direction determination unit that determines a traveling direction of a traffic lane around the own traffic lane including the another traffic lane based on a traveling direction of the own traffic lane, a start direction of the started another vehicle, and a traffic lane position of the another traffic lane.

An onboard electronic control method includes: recognizing another vehicle that starts from a stopped state in another traffic lane different from an own traffic lane in which an own vehicle travels; and determining a traveling direction of a traffic lane around the own traffic lane including the another traffic lane based on a traveling direction of the own traffic lane, a start direction of the started another vehicle, and the traffic lane position of the another traffic lane.

### Advantageous Effects of Invention

The onboard electronic control device and the onboard electronic control method capable of appropriately changing the control of the ACC function without depending on the map data when the own vehicle next passes another vehicle by protruding to the opposite traffic lane based on a traffic lane traveling direction determination method without erroneous determination in consideration of the another vehicle that passes the own vehicle by protruding to the opposite traffic lane can be inexpensively provided.

### BRIEF DESCRIPTION OF DRAWINGS

FIG. 1 is a view illustrating a configuration example of an onboard electronic control device according to an embodiment of the present invention.

FIG. 2 is a view illustrating a state where a traffic light is on a red light at an intersection describing the present embodiment.

FIG. 3 is a view illustrating a state in which the traffic light has changed from the red light to a green light at the intersection describing the present embodiment.

FIG. 4 is an overhead view illustrating a recognition region of an outside recognition sensor describing the present embodiment.

FIG. 5 is an overhead view illustrating a stop and start scene of a vehicle at consecutive intersections describing the present embodiment.

FIG. 6 is an overhead view illustrating a traffic lane decrease scene describing the present embodiment.

FIG. 7 is an overhead view illustrating a scene in which a vehicle turns left at the intersection describing the present embodiment.

FIG. 8 is an overhead view illustrating a passing scene during an ACC control change describing the present embodiment.

FIG. 9 is a flowchart illustrating a processing operation according to the present embodiment.

FIG. 10 is a flowchart illustrating a processing operation according to the present embodiment.

FIG. 11 is an overhead view illustrating a vehicle passing scene during ACC control describing a background art of the present invention.

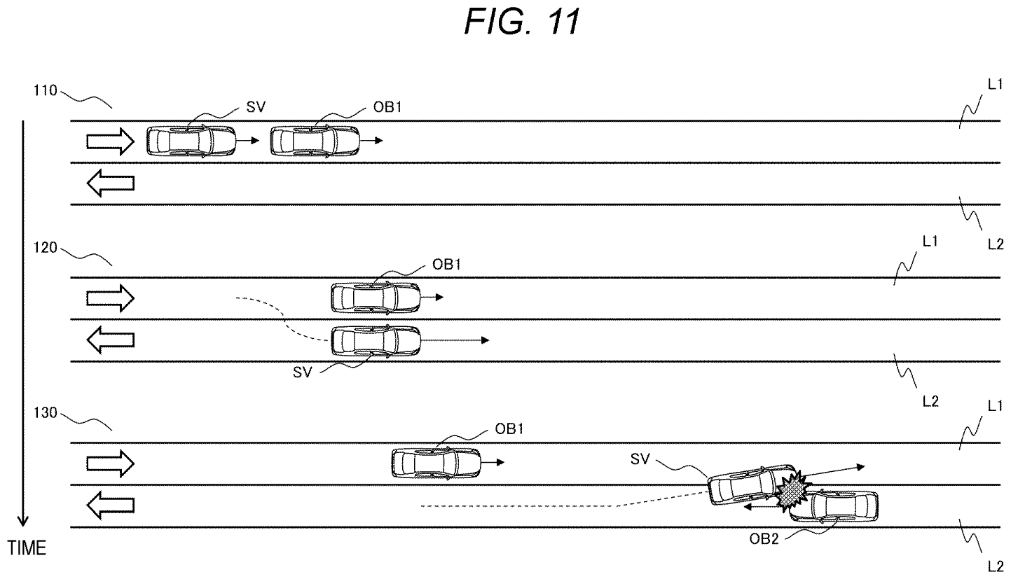

### DESCRIPTION OF EMBODIMENT

Hereinafter, an embodiment of the present invention will be described with reference to the drawings.

### Embodiment

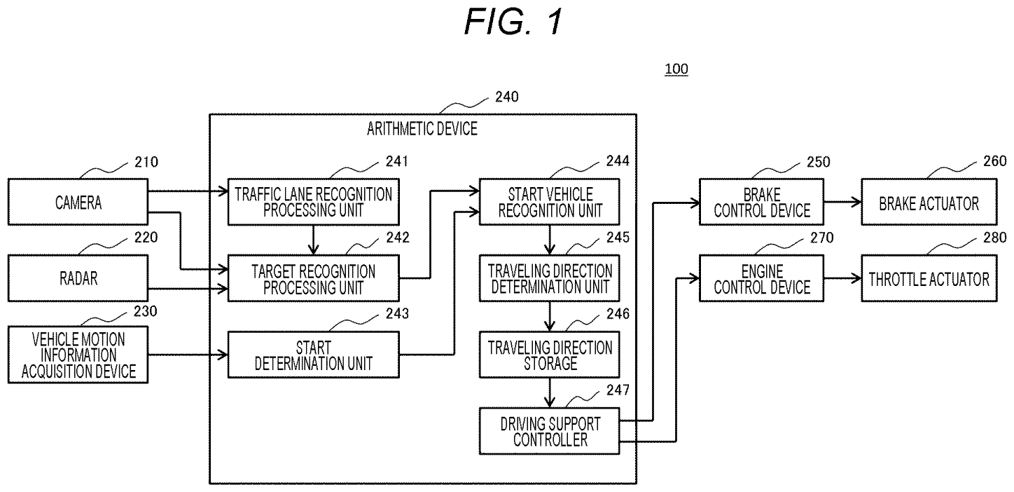

FIG. 1 is a view illustrating a configuration example of an onboard electronic control device 100 according to an embodiment of the present invention.

The onboard electronic control device 100 in FIG. 1 is mounted on a vehicle and includes a camera 210, a radar 220, a vehicle motion information acquisition device 230, an arithmetic device 240, a brake control device 250, a brake actuator 260, an engine control device 270, and a throttle actuator 280.

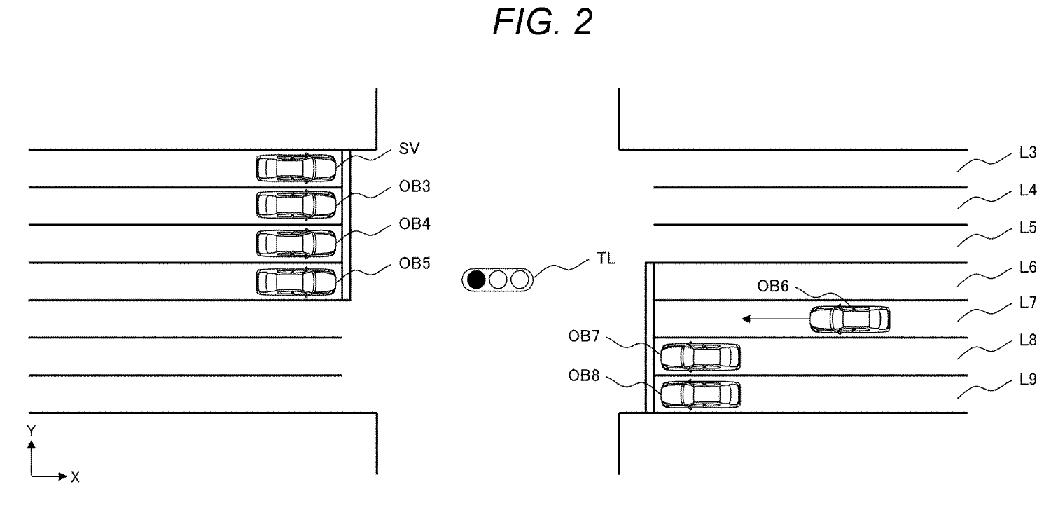

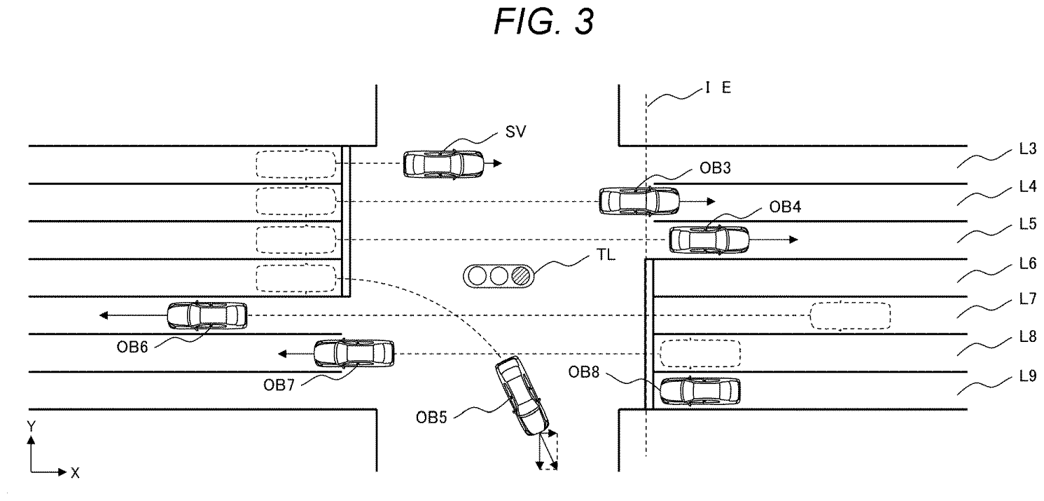

In addition, in describing a processing content of each component in the present embodiment, a scene in which a traffic light TL changes from a red light state as illustrated in FIG. 2 to a green light as illustrated in FIG. 3 will be considered as a representative example.

In the embodiment illustrated in FIG. 1, the camera 210 is an outside recognition sensor using an imaging element, recognizes an object, calculates target information such as a relative position, a relative speed vector, and a type with respect to an own vehicle SV, and calculates white line information such as a relative position between the own vehicle SV and a peripheral white line and an approximate expression of the white line. A recognition target is mainly the vehicle, and may include a traffic light or a traffic sign. In this case, a light color of the traffic light TL to be turned on and a regulation content of the traffic sign are also determined.

The radar 220 is the outside recognition sensor using a millimeter wave, a laser, or the like, recognizes the object, and calculates target information such as a relative position, a relative speed vector, and a type with respect to the own vehicle SV. Although the radar 220 is illustrated here, the outside recognition sensor such as sonar using an ultrasonic wave or LiDAR that scans the laser in a wide range may be used.

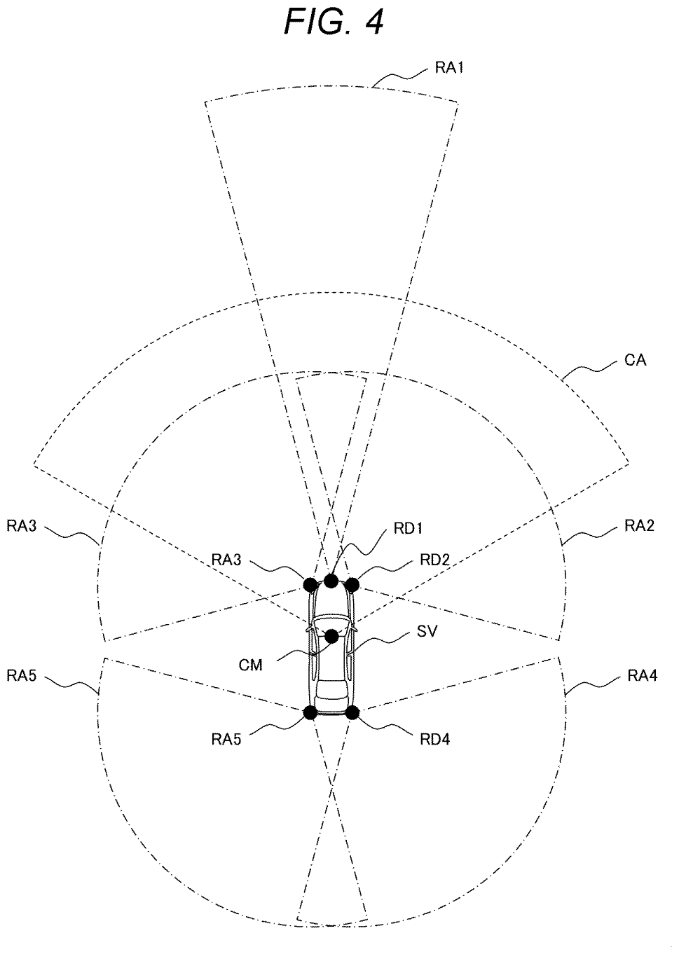

In the embodiment, the camera 210 and the radar 220 are mounted on the own vehicle SV as illustrated in FIG. 4 so as to cover an entire periphery of the own vehicle SV as a recognition range. A front camera CM is mounted toward a front of the own vehicle SV and covers a front camera recognition region CA. A front center radar RD1 is also mounted toward the front of the own vehicle SV, and covers a front center radar recognition region RA1 including a region farther than the front camera CM. Front corner radars RD2, RD3 are mounted toward to left and right diagonal forward sides of the own vehicle SV, and cover front corner radar recognition regions RA2, RA3. Rear corner radars RD4, RD5 are mounted toward the left and right diagonal rear sides of the own vehicle SV, and cover rear corner radar recognition regions RA4, RA5.

The vehicle motion information acquisition device 230 includes a vehicle speed sensor that acquires vehicle speed information about the own vehicle SV, a yaw rate sensor that acquires yaw rate information, an accelerator opening sensor that acquires accelerator opening information, and the like, and acquires vehicle motion information in which the vehicle speed sensor, the yaw rate sensor, the accelerator opening sensor, and the like are collected.

The arithmetic device 240 is mounted on an ECU including a CPU and a memory (ROM, RAM), and executes various processing programs previously stored in the memory. The arithmetic device 240 includes functional blocks of a traffic lane recognition processing unit 241, a target recognition processing unit 242, a start determination unit 243 (own vehicle start determination unit), a start vehicle recognition unit 244, a traveling direction determination unit 245, a traveling direction storage unit 246, and a driving support controller 247.

The traffic lane recognition processing unit 241 estimates the position (region) of the traffic lane around the own vehicle based on the white line information calculated by the camera 210. By this processing, regions of traffic lanes L3 to L9 around the own vehicle SV are estimated in each situation illustrated in FIGS. 2 and 3.

The target recognition processing unit 242 determines another vehicle traveling in each traffic lane around the own vehicle based on the target information calculated by the camera 210 and the radar 220 and traffic lane region information. By this processing, the relative position, the relative speed, and the type of other vehicles OB3 to OB8 are calculated in each situation illustrated in FIGS. 2 and 3. At the same time, based on the region information about each traffic lane and the relative position information about each another vehicle, it is determined that the own vehicle SV belongs to the traffic lane L3, another vehicle OB3 belongs to the traffic lane L4, another vehicle OB4 belongs to the traffic lane L5, another vehicle OB5 belongs to the traffic lane L6, another vehicle OB6 belongs to the traffic lane L7, another vehicle OB7 belongs to the traffic lane L8, and another vehicle OB8 belongs to the traffic lane L9.

The start determination unit 243 determines that the own vehicle SV starts from a stopped state based on the vehicle motion information acquired by the vehicle motion information acquisition device 230, and generates own vehicle start information. By this processing, the start information about the own vehicle SV is generated in the situation illustrated in FIG. 3. The traveling direction determination unit 245 can also be configured to determine the traveling direction of the traffic lane around the own traffic lane when the own vehicle start determination unit 243 determines that the own vehicle SV starts.

When it is determined that the own vehicle SV starts based on the own vehicle start information, the vehicle speed information and the yaw rate information about the own vehicle SV, and relative speed vector information about another vehicle, the start vehicle recognition unit 244 recognizes another vehicle that starts from the stopped state before the intersection in another traffic lane and passes through the intersection in the same direction as the traveling direction of the own vehicle SV as an in-start forward traveling another vehicle. That is, the start vehicle recognition unit 244 recognizes another vehicle that starts from the stopped state in another traffic lane different from the own traffic lane in which the own vehicle SV travels based on a recognition result of the camera 210 or the radar 220 that is the outside recognition sensor mounted on the own vehicle SV.

Specifically, an absolute velocity vector of the own vehicle SV is calculated based on the vehicle speed information and the yaw rate information with the own vehicle start information as a trigger. Furthermore, the absolute velocity vector of each another vehicle is calculated from the absolute velocity vector of the own vehicle SV and the relative velocity vector information about each another vehicle. At this point, it is determined that another vehicle in which magnitude (absolute value) of the absolute speed vector shifts from a value close to zero to an increase starts from the stopped state.

Subsequently, the direction of the absolute speed vector of the own vehicle SV and the direction of the absolute speed vector of another vehicle are compared for a specified time (for example, about 5 seconds), and another vehicle (forward traveling vehicle) having the same traveling direction as the own vehicle SV is determined. At this point, in the case of a traveling direction X of the own vehicle SV and a direction Y orthogonal to the traveling direction X, the absolute velocity vectors of the own vehicle SV and another vehicle are considered to be decomposed in an X-direction and a Y-direction. In the case where an X-component of the absolute velocity vector of another vehicle is a square value and the difference between the Y-component of the absolute velocity vector of the own vehicle SV and a Y-component of the absolute velocity vector of another vehicle converges to a small value, it is provisionally determined that the another vehicle is a forward traveling vehicle.

Finally, among other vehicles that are provisionally determined to be forward traveling vehicles, another vehicle that passes through an intersection terminal IE during the specified time (for example, about 5 seconds after the own vehicle SV passes through the intersection terminal IE) is determined to be the forward traveling vehicle, and this is finally determined as an in-start forward traveling vehicle. By this processing, it is determined that other vehicles OB3, OB4, OB5, OB7 start from the stopped state in the situation illustrated in FIG. 3. Among these, the X-component of the another vehicle OB7 has a negative value, and the difference in the Y-component from the own vehicle SV diverges in the another vehicle OB5, so that other vehicles OB5, OB7 are determined not to be a forward traveling vehicle. On the other hand, the X-component converges to a positive value and the difference in the Y-component from the own vehicle SV converges to zero in other vehicles OB3, OB4, and other vehicles OB3, OB4 have passed the intersection terminal IE, so that it is determined that other vehicles OB3, OB4 are the in-start forward traveling vehicles.

The traveling direction determination unit 245 determines the traveling direction of the traffic lane around the own traffic lane including another traffic lane based on a start direction of the own traffic lane, the start direction of started another vehicle, and the traffic lane position of another traffic lane. That is, when the in-start forward traveling vehicle exists in any traffic lane on a first side (a right side for left side traveling, a left side for right side traveling), the traveling direction determination unit 245 determines the traffic lane on the second side (the left side for the left side traveling, the right side for the right side traveling) from the traffic lane to which the in-start forward traveling vehicle belongs as the forward traveling traffic lane based on in-start forward traveling vehicle information located in the traffic lane farthest from the own vehicle SV on the first side.

On the other hand, when there is no in-start forward traveling vehicle around the own vehicle SV, when the own vehicle SV is traveling on the first side of the forward traveling traffic lane, or the like, the forward traveling vehicle on the first side of the own vehicle SV cannot be recognized, and the above determination cannot be made. In such a case, the traffic lane on the second side of the own traffic lane is provisionally determined as a forward traffic lane.

By this processing, among other vehicles OB3, OB4 determined to be the in-start forward traveling vehicles, the traffic lane L5 to which the another vehicle OB4 located farthest on the right side of the own vehicle SV belongs and the traffic lanes L3, L4 on the left side of the traffic lane L5 are determined to be the forward traveling traffic lanes.

The traveling direction storage unit 246 stores or updates forward traveling traffic lane determination result determined by the traveling direction determination unit 245, and updates or erases the stored traveling direction of the traffic lane according to an increase or decrease in the number of traffic lanes on the road on which the own vehicle SV travels or a right turn or a left turn of the own vehicle SV. Specifically, the forward traveling traffic lane determination result is stored while it is determined that the recognized continuity of each traffic lane exists, and the latest forward traveling traffic lane determination result is updated when the number of traffic lanes determined to be the forward traveling traffic lane increases.

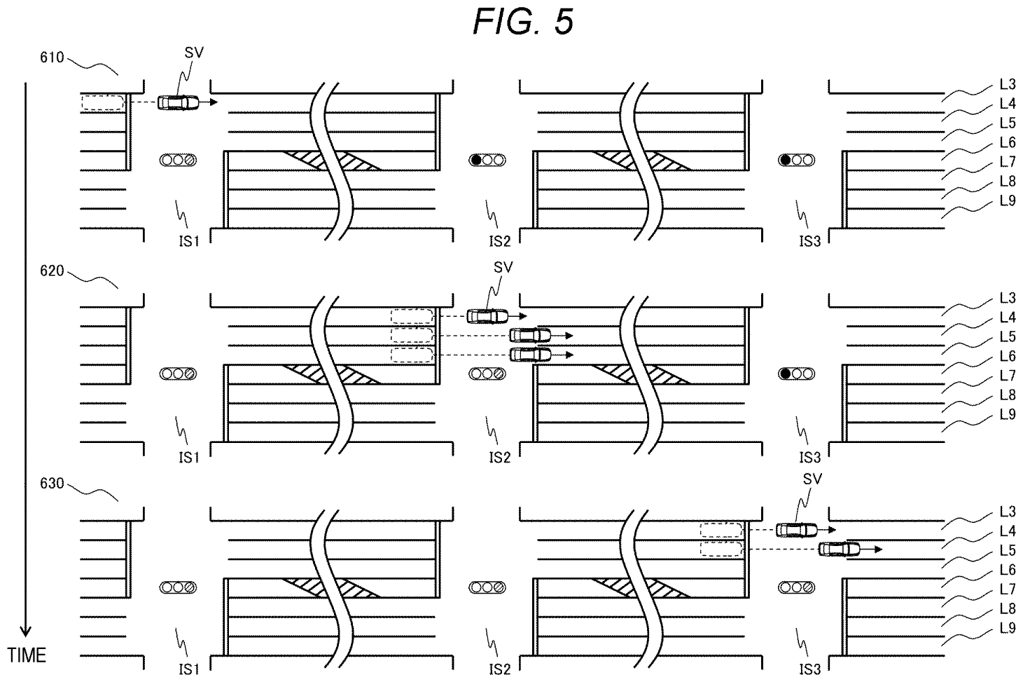

For example, consider a scene in which the start from the stopped state is repeated at consecutive intersections IS1, IS2, IS3 as illustrated in FIG. 5. In a start scene 610 at the intersection IS1, it is determined and stored that there is no another vehicle around the own vehicle SV and only the traffic lane L3 is the forward traveling traffic lane.

Subsequently, in a start scene 620 at the intersection IS2, it is determined that the traffic lanes L3, L4, L5 are the forward traveling traffic lanes from the information about the in-start forward traveling vehicles around the own vehicle SV. At this time, because the traffic lanes L4, L5 are newly determined to be the forward traveling traffic lanes (the number of traffic lanes determined to be the forward traveling traffic lane increases), the storage is updated in the forward traveling traffic lane determination result.

Furthermore, in a start scene 630 at the intersection IS3, it is determined that the traffic lanes L3, L4 are the forward traveling traffic lanes from the information about the in-start forward traveling vehicle around the own vehicle SV. At this time, because the traffic lanes L3, L4 are already stored as the forward traveling traffic lanes and the number of traffic lanes determined as the normal driving traffic lanes does not increase, the storage is not updated but the previous storage (storage that the traffic lanes L3, L4, L5 are the forward traveling traffic lanes) is held.

When there is the traffic lane determined to have no continuity due to the increase or decrease in the number of traffic lanes on the road, the right turn or the left turn of the own vehicle SV, or the like in the determination of the update or hold of the storage, the forward traveling traffic lane determination result of the traffic lane may be updated while deleted.

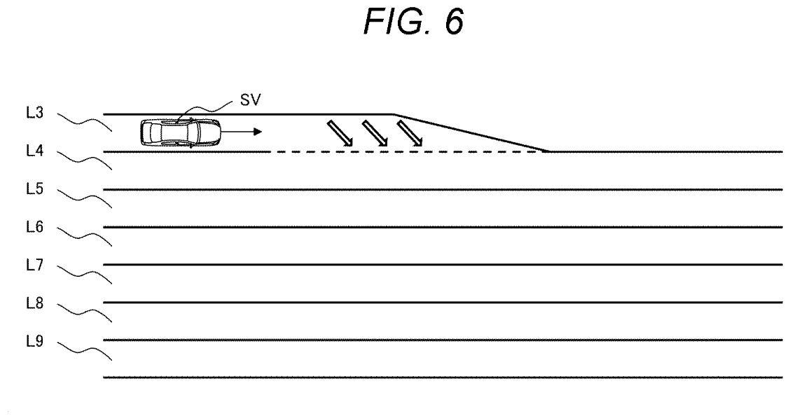

For example, the case where a traffic lane increase or decrease of the road is generated is considered as a first example. In the situation illustrated in FIG. 3, after the traffic lanes L3 to L5 are stored as the forward traveling traffic lanes, when the traffic lane decrease is generated as illustrated in FIG. 6, the storage that the traffic lane L3 is the forward traveling traffic lane is erased, and the storage is updated when the traffic lanes L4, L5 are the forward traveling traffic lanes. at this point, the forward traveling traffic lane determination result may be deleted not only for the traffic lane determined to have no continuity but also for all the traffic lanes recognized at that time.

Subsequently, the case where the own vehicle SV makes the right or left turn will be considered as a second example.

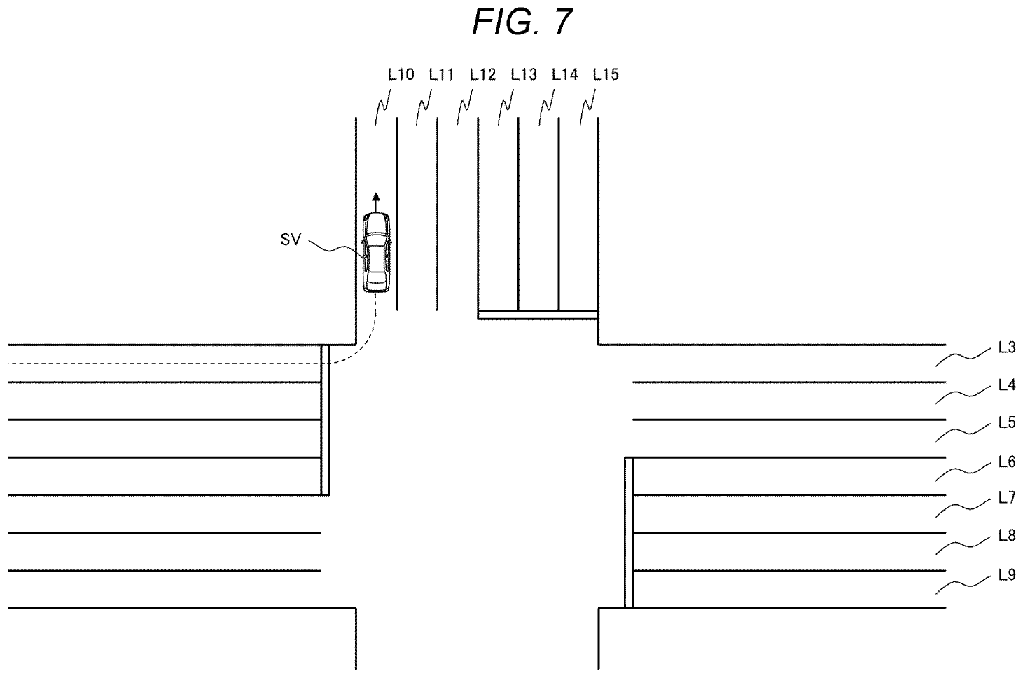

In the situation illustrated in FIG. 3, after the traffic lane L3 to the traffic lane L5 are stored as the forward traffic lane, when the own vehicle SV turns left as illustrated in FIG. 7, the storage that the traffic lanes L3 to L9 are the forward traffic lanes is deleted, and the traveling direction determination of the traffic lanes L10 to L15 is newly started.

The driving support controller 247 controls the speed of the own vehicle SV so as to follow a preceding vehicle traveling in front of the own vehicle SV. In addition, the driving support controller 247 changes the speed of the own vehicle SV based on the traveling direction of the own vehicle SV and the traveling direction of the traffic lane determined by the traveling direction determination unit 245. That is, when determining that the own traffic lane in which the vehicle is currently traveling is not the forward traveling traffic lane based on the forward traveling traffic lane determination result and the own traffic lane information that are stored in the traveling direction storage unit 246, the driving support controller 247 reduces the set vehicle speed of the ACC function to the vehicle speed before the traffic lane change and resets the vehicle speed of the ACC function, and transmits a brake control command and an engine control command corresponding to the reset vehicle speed. At this point, timing before the traffic lane change is specifically timing at which a front tire of the own vehicle SV protrudes to the adjacent traffic lane region, and the vehicle speed at this time is the set vehicle speed of the ACC function.

However, when sudden acceleration exceeding specified acceleration (for example, 2.0 m/s²) is detected during the specified time (for example, about 5 seconds) before the timing of the adjacent traffic lane protrusion, the vehicle speed at the timing of the sudden acceleration start becomes the set vehicle speed of the ACC function.

When the set vehicle speed determined by a set vehicle speed resetting method is higher than an original driver set vehicle speed, the set vehicle speed of the ACC function is maintained at the driver set vehicle speed.

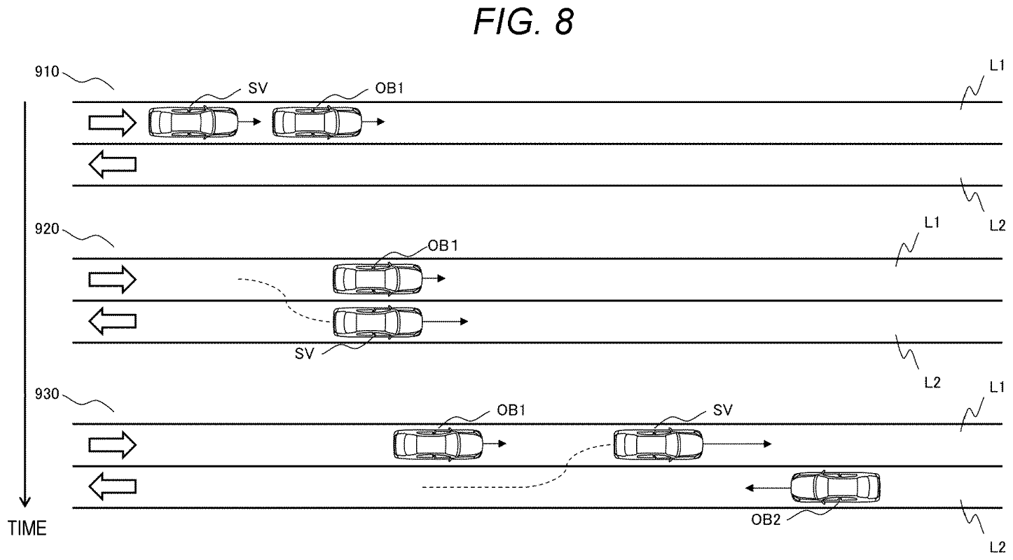

Referring to FIG. 8, in a preceding vehicle catching up scene 910, it is determined that an own traffic lane L1 is the forward traveling traffic lane and an opposite traffic lane L2 is not the forward traveling traffic lane while the own traffic lane L1 is traveling at the set vehicle speed using the ACC function. In addition, when the own vehicle SV catches up the preceding vehicle OB1, the own vehicle SV keeps a constant inter-vehicle distance and follows (decelerates) the preceding vehicle OB1. Subsequently, in a preceding vehicle passing scene 920, passing is performed by protruding to the opposite traffic lane L2. At this point, based on the determination result that the opposite traffic lane L2 is not the forward traveling traffic lane, the ACC set vehicle speed is reduced to the vehicle speed before the traffic lane change (before passing is started) by the processing according to the embodiment of the present invention. In the embodiment of the present invention, unlike the conventional ACC control, the own vehicle SV does not automatically accelerate, and the driver presses down an accelerator pedal to perform the acceleration and speed adjustment.

In an original traffic lane returning scene 930, the case where an oncoming vehicle OB2 is approaching is considered. At this time, the driver performs speed adjustment, and a possibility of causing a collision with the oncoming vehicle OB2 can be reduced as compared with the conventional ACC control. In the above description, reducing the ACC setting vehicle speed has been described as the control change example. However, the ACC function may be released. In addition, even when it is determined that the own traffic lane is the forward traveling traffic lane, as illustrated in FIG. 6, when the own traffic lane decreases further and when the driver does not change the traffic lane, the ACC function is canceled.

The brake control device 250 transmits a brake actuator operation command based on the brake control command transmitted from the driving support controller 247.

The brake actuator 260 controls brake fluid pressure based on the brake actuator operation command transmitted from the brake control device 250.

The engine control device 270 transmits a throttle actuator operation command based on the engine control command transmitted from the driving support controller 247.

The throttle actuator 280 controls a throttle valve opening based on the throttle actuator operation command transmitted from the engine control device 270.

In the embodiment, the control change of the ACC function has been described, but the control change of the driving assistance function other than the ACC function may be performed based on the forward traveling traffic lane determination result. For example, it is conceivable to apply the present invention to an automobile line change function that automatically changes the traffic lane in response to a winker operation of the driver. Also with regard to this function, in the scene where the passing is performed while the vehicle protrudes to the opposite traffic lane, there is the possibility that the collision with the oncoming vehicle is induced similarly to the ACC function, and it is necessary to appropriately change the control.

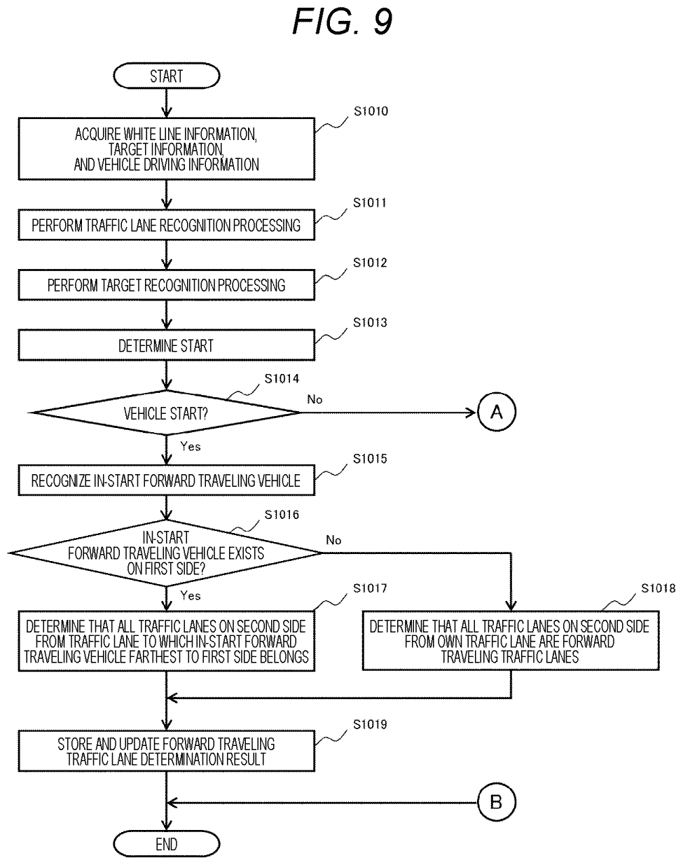

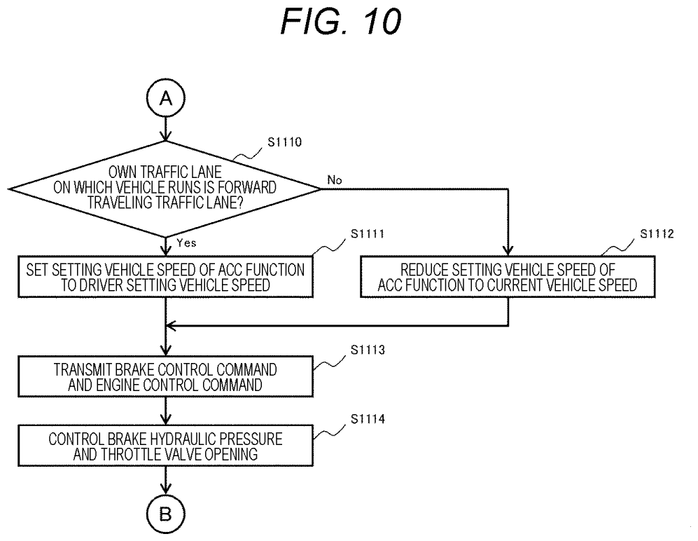

A processing flow of the embodiment will be described with reference to flowcharts illustrated in FIGS. 9 and 10. This processing is repeatedly executed in the arithmetic device 240 at a predetermined cycle.

First, in step S1010 of FIG. 9, the white line information and the target information are acquired from the camera 210, the target information is acquired from the radar 220, and the vehicle motion information is acquired from the vehicle motion information acquisition device 230.

In step S1011, the traffic traffic lane recognition processing unit 241 estimates the region of the traffic lane around the own vehicle SV based on the white line information.

In step S1012, the target recognition processing unit 242 determines another vehicle traveling in each traffic lane around the own vehicle SV based on the target information and the traffic lane region information.

In step S1013, the start determination unit 243 determines that the own vehicle SV starts from the stopped state based on the vehicle motion information, and generates the own vehicle start information.

In step S1014, the start vehicle recognition unit 244 determines whether the own vehicle start information is generated. When an affirmative determination is made in step S1014, the processing proceeds to step S1015. When a negative determination is made in step S1014 (the own vehicle does not start from the stopped state), the processing proceeds to step S1110 in FIG. 10.

In step S1015, when it is determined that the own vehicle SV starts, the start vehicle recognition unit 244 recognizes another vehicle that starts from the stopped state in another traffic lane. That is, the start vehicle recognition unit 244 recognizes another vehicle that starts from the stopped state in another traffic lane and passes through the intersection in the same direction as the traveling direction of the own vehicle SV based on the own vehicle start information, the vehicle speed information and the yaw rate information about the own vehicle SV, and the relative speed vector information about another vehicle.

In step S1016, the traveling direction determination unit 245 determines whether the in-start forward traveling vehicle exists in any traffic lane on the first side (the right side when the forward traveling direction of the vehicle is the left side (left side traveling), and the left side when the forward traveling direction of the vehicle is the right side (right side traveling)). When the affirmative determination is made in step S1016, the processing proceeds to step S1017. When the negative determination is made in step S1016, the processing proceeds to step S1018.

In step S1017, the traveling direction determination unit 245 determines that the traffic lane on the second side (left side when vehicle forward traveling direction is left side (left side traveling), right side when vehicle forward traveling direction is right side (right side traveling)) from the traffic lane to which the in-start forward traveling vehicle belongs is the forward traveling traffic lane based on the in-start forward traveling vehicle information located in the traffic lane farthest from the own vehicle SV on the first side.

In step S1018, the traveling direction determination unit 245 determines that the traffic lane on the second side from the own traffic lane is the forward traveling traffic lane.

In step S1019, the traveling direction storage unit 246 stores and updates the forward traveling traffic lane determination result, and updates or erases the stored traveling direction of the traffic lane according to the increase or decrease in the number of traffic lanes on the road on which the own vehicle SV travels and the right or left turn of the own vehicle SV. In step S1110 of FIG. 10, the driving support controller 247 determines whether the current traveling traffic lane is the forward traveling traffic lane based on the forward traveling traffic lane determination result and the own traffic lane information that are stored in the traveling direction storage unit 246. When the affirmative determination is made in step S1110, the processing proceeds to step S1111. When the negative determination is made in step S1110, the processing proceeds to step S1112.

In step S1111, the driving support controller 247 sets the set vehicle speed of the ACC function to the driver set vehicle speed, and transmits the brake control command and the engine control command corresponding to the driver set vehicle speed. Then, the processing proceeds to step S1113.

In step S1112, the driving support controller 247 lowers the set vehicle speed of the ACC function to the vehicle speed before the traffic lane change (changes to the traveling speed) and resets the ACC function to the vehicle speed before the traffic lane change, and transmits the brake control command and the engine control command corresponding to the lowered set vehicle speed. Then, the processing proceeds to step S1113.

In step S1113, the brake control device 250 transmits the brake actuator operation command based on the brake control command transmitted from the driving support controller 247. At the same time, the engine control device 270 transmits the throttle actuator operation command based on the engine control command transmitted from the driving support controller 247.

In step S1114, the brake actuator 260 controls the brake fluid pressure based on the brake actuator operation command transmitted from the brake control device 250. At the same time, the throttle actuator 280 controls the throttle valve opening based on the throttle actuator operation command transmitted from the engine control device 270. Then, the processing ends.

As described above, according to the embodiment of the present invention, the traffic lane traveling direction determination can be implemented without erroneous determination in consideration of another vehicle that passes the own vehicle by protruding to the opposite traffic lane, and the onboard electronic control device and the onboard electronic control method that appropriately change the control of the ACC function without depending on the map data can be inexpensively provided when the own vehicle passes another vehicle while protruding to the opposite traffic lane.

### REFERENCE SIGNS LIST

100 onboard electronic control device
210 camera
220 radar
230 vehicle motion information acquisition device
240 arithmetic device
241 traffic lane recognition processing unit
242 target recognition processing unit
243 start determination unit (own vehicle start determination unit)
244 start vehicle recognition unit
245 traveling direction determination unit
246 traveling direction storage unit
247 driving support controller
250 brake control device
260 brake actuator
270 engine control device
280 throttle actuator
SV own vehicle

1. An onboard electronic control device comprising:
a start vehicle recognition unit that recognizes another vehicle starting from a stopped state in another traffic lane different from an own traffic lane in which an own vehicle travels based on a recognition result of an outside recognition sensor mounted on the own vehicle; and
a traveling direction determination unit that determines a traveling direction of a traffic lane around the own traffic lane including the other traffic lane based on a traveling direction of the own traffic lane, a start direction of the started other vehicle, and a traffic lane position of the other traffic lane.

2. The onboard electronic control device according to claim 1, further comprising an own vehicle start determination unit that determines that the own vehicle starts from the stopped state, wherein the start vehicle recognition unit recognizes the other vehicle that starts from the stopped state in the other traffic lane when it is determined that the own vehicle starts.

3. The onboard electronic control device according to claim 1, further comprising an own vehicle start determination unit that determines that the own vehicle starts from a stopped state, wherein the traveling direction determination unit determines a traveling direction of a traffic lane around the own traffic lane when the own vehicle start determination unit determines that the own vehicle starts.

4. The onboard electronic control device according to claim 1, wherein the traveling direction determination unit determines the traveling direction of the traffic lane located on a second side of the traffic lane from a first side based on the start direction of the other vehicle that starts in the traffic lane on the first side, with one of both sides of the own traffic lane as the first side and another side as the second side.

5. The onboard electronic control device according to claim 4, wherein the traveling direction determination unit determines a traffic lane located on the second side of a traffic lane in which a vehicle starts in a direction identical to the traveling direction of the own traffic lane on the first side is a forward traveling traffic lane that is the traveling direction identical to the own traffic lane.

6. The onboard electronic control device according to claim 1, further comprising a traveling direction storage unit that stores the traveling direction of the traffic lane determined by the traveling direction determination unit, wherein the traveling direction storage unit updates or erases the stored traveling direction of the traffic lane according to an increase or decrease in a number of traffic lanes of a road on which the own vehicle travels or a right or left turn of the own vehicle SV.

7. The onboard electronic control device according to claim 1, further comprising a driving support controller that controls speed of the own vehicle so as to catch up with a preceding vehicle traveling in front of the own vehicle at a previously set speed, decelerate, and follow the preceding vehicle, wherein the driving support controller changes the speed of the own vehicle based on the traveling direction of the own vehicle and the traveling direction of the traffic lane determined by the traveling direction determination unit.

8. The onboard electronic control device according to claim 2, wherein the start vehicle recognition unit recognizes another vehicle that passes through an intersection in a direction identical to the traveling direction of the own vehicle as the started other vehicle when the other vehicle on the other traffic lane starts from the stopped state before the intersection.

9. The onboard electronic control device according to claim 7, further comprising a traveling direction storage unit that stores a traveling direction of a traffic lane determined by the traveling direction determination unit, wherein the driving support controller changes a control speed of the own vehicle from the previously set speed to a traveling speed before the traffic lane change when it is determined that a traffic lane on which the own vehicle travels is changed and the own traffic lane is not a forward traveling traffic lane based on the traveling direction of the traffic lane stored in the traveling direction storage unit and a position of the own traffic lane on which the own vehicle currently travels.

10. The onboard electronic control device according to claim 4, wherein the first side is a right side when the forward traveling direction of the own vehicle is a left side, the first side is the left side when the forward traveling direction of the own vehicle is the right side, the second side is the left side when the forward traveling direction of the own vehicle is the left side, and the second side is the right side when the forward traveling direction of the own vehicle is the right side.

11. An onboard electronic control method comprising:
recognizing another vehicle that starts from a stopped state in another traffic lane different from an own traffic lane in which an own vehicle travels; and
determining a traveling direction of a traffic lane around the own traffic lane including the other traffic lane based on a traveling direction of the own traffic lane, a start direction of the started other vehicle, and the traffic lane position of the other traffic lane.

12. The onboard electronic control method according to claim 11, further comprising:
determining whether the own vehicle starts from the stopped state; and
recognizing the other vehicle that starts 1 from the stopped state in the other traffic lane when it is determined that the own vehicle starts.
